(19) United States
(12) Patent Application Publication
(10) Pub. No.: US 2019/0116597 A1
(43) Pub. Date: Apr. 18, 2019

(54) MOBILE DEVICE AND UPLINK DATA TRANSMISSION METHOD THEREOF

(71) Applicant: Institute For Information Industry, Taipei (TW)

(72) Inventors: Feng-Ming YANG, Taipei City (TW); Chih-Yuan LO, Tainan City (TW); Shu-Han LIAO, New Taipei City (TW)

(21) Appl. No.: 15/867,662

(22) Filed: Jan. 10, 2018

(30) Foreign Application Priority Data
Oct. 17, 2017 (TW) 106135484

(51) Int. Cl. H04W 72/04; H04W 72/12

(52) U.S. Cl. CPC H04W 72/0486; H04W 72/0446; H04W 72/1284; H04W 72/042

(57) ABSTRACT

A mobile device and an uplink data transmission method thereof are provided. A heterogeneous network system includes an LTE base station, an NR base station and the mobile device. The mobile station receives an RRC message, which includes a data duplication cease threshold, from the LTE base station. The mobile device determines an under-transmission data parameter within a buffer time period. The mobile station determines whether the under-transmission data parameter exceeds the data duplication cease threshold. If negative, the mobile device initiates a data duplication transmission procedure which includes: transmitting main data to the LTE base station directly; and transmitting copy data of the main data to the LTE base station via the NR base station. If positive, the mobile device ceases the data duplication transmission procedure.

### PRIORITY

This application claims priority to Taiwan Patent Application No. 106135484 filed on Oct. 17, 2017, which is hereby incorporated by reference in its entirety.

### FIELD

The present invention relates to a mobile device and an uplink data transmission method thereof. More particularly, the present invention relates to a mobile device under a heterogeneous network system and an uplink data transmission method thereof.

### BACKGROUND

As compared to the 4^{th} Generation (4G) network system, the 5^{th} Generation (5G) network system has a faster data transmission speed and a more flexible network resource utilization mode. The New Radio (NR) network is a communication protocol in the 5G network system that is developing vigorously. Specifically, the NR network communication protocol is mainly a new radio standard based on orthogonal frequency-division multiplexing. As compared to the Long Term Evolution (LTE) network of the 4G network system, the NR network communication protocol has a broader available network frequency band.

Since the NR network is still under development currently, the architecture of the LTE network is still used in combination with the architecture of the NR network. Accordingly, in such a heterogeneous network system comprising different communication protocols, the mobile device connects with a base station of the NR network and a base station of the LTE network respectively via different communication modules.

Further speaking, in the case where the mobile device selects the base station of the LTE network as a main base station and selects the base station of the NR network as a secondary base station based on a packet data convergence protocol (PDCP), if a data amount of a main PDCP datum to be transmitted to the LTE base station exceeds a preset threshold, then the mobile device will generate a PDCP copy datum that is the same as the main PDCP datum and transmit the PDCP copy datum to the LTE base station via the NR base station in consideration of the reliability of data transmission. In this way, correct and complete data transmission can be ensured.

However, network resources of the LTE base station used for data transmission with the mobile device are limited. Therefore, if the NR base station forwards the PDCP copy datum of the mobile device to the LTE base station when the mobile device is transmitting the PDCP main datum to the LTE base station, the operation loading of the LTE base station will be closely affected. In other words, when the amount of the PDCP data from the NR base station to be processed by the LTE base station increases, the loading of the LTE base station increases remarkably, which in turn influences the overall processing efficiency of the network data.

Accordingly, an urgent need exists in the art to improve the aforesaid problem so as to improve the overall utilization efficiency of network resources.

### SUMMARY

Provided is an uplink data transmission method for a mobile device. The mobile device is used in a heterogeneous network system. The heterogeneous network system includes a Long Term Evolution (LTE) base station, a New Radio (NR) base station and the mobile device. The LTE base station and the NR base station have a network connection therebetween. The mobile device has a connection with the LTE base station and the NR base station respectively.

The disclosure includes an uplink data transmission method, which may comprise: receiving, by the mobile device, a Radio Resource Control (RRC) message from the LTE base station, wherein the RRC message comprises a data duplication cease threshold; determining, by the mobile device, a first under-transmission data parameter within a buffer time period; and determining, by the mobile device, whether the first under-transmission data parameter exceeds the data duplication cease threshold.

Next, if the mobile device determines that the first under-transmission data parameter does not exceed the data duplication cease threshold, the mobile device can initiate a data duplication transmission procedure. The data duplication transmission procedure includes: transmitting, by the mobile device, at least one main datum to the LTE base station directly; and transmitting, by the mobile device, at least one copy datum of the at least one main datum to the LTE base station via the NR base station. On the other hand, if the mobile device determines that the first under-transmission data parameter exceeds the data duplication cease threshold, the mobile device will not initiate the data duplication transmission procedure.

The disclosure also includes a mobile device for use in a heterogeneous network system. The heterogeneous network system includes an LTE base station, an NR base station and the mobile device. The LTE base station and the NR base station have a network connection therebetween. The mobile device comprises a transceiver and a processor. The transceiver is configured to connect with the LTE base station and the NR base station respectively and receive an RRC message from the LTE base station. The RRC message comprises a data duplication cease threshold.

The processor can be is configured to: determine a first under-transmission data parameter within a buffer time period; determine whether the first under-transmission data parameter exceeds the data duplication cease threshold. If the processor determines that the first under-transmission data parameter does not exceed the data duplication cease threshold, the processor initiates a data duplication transmission procedure. The data duplication transmission procedure includes: transmitting at least one main datum to the LTE base station through the transceiver; and transmitting at least one copy datum of the at least one main datum to the LTE base station via the NR base station and through the transceiver. On the contrary, if the processor determines that the first under-transmission data parameter exceeds the data duplication cease threshold, the processor will not initiate the data duplication transmission procedure.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a heterogeneous network system according to a first embodiment of the present invention;

FIG. 1B is a block diagram of a mobile device according to the first embodiment of the present invention;

FIG. 2A is a schematic view of a heterogeneous network system according to a second embodiment of the present invention;

FIG. 2B is a block diagram of a mobile device according to the second embodiment of the present invention;

FIG. 3 is a flowchart diagram of an uplink data transmission method according to a third embodiment of the present invention; and

FIG. 4A to FIG. 4C are flowchart diagrams of an uplink data transmission method according to a fourth embodiment of the present invention.

### DETAILED DESCRIPTION

In the following description, the present invention will be explained with reference to certain example embodiments thereof. However, these example embodiments are not intended to limit the present invention to any specific example, embodiment, environment, applications or implementations described in these example embodiments. Therefore, description of these example embodiments is only for purpose of illustration rather than to limit the present invention.

In the following embodiments and the attached drawings, elements unrelated to the present invention are omitted from depiction; and dimensional relationships among individual elements in the attached drawings are illustrated only for ease of understanding, but not to limit the actual scale.

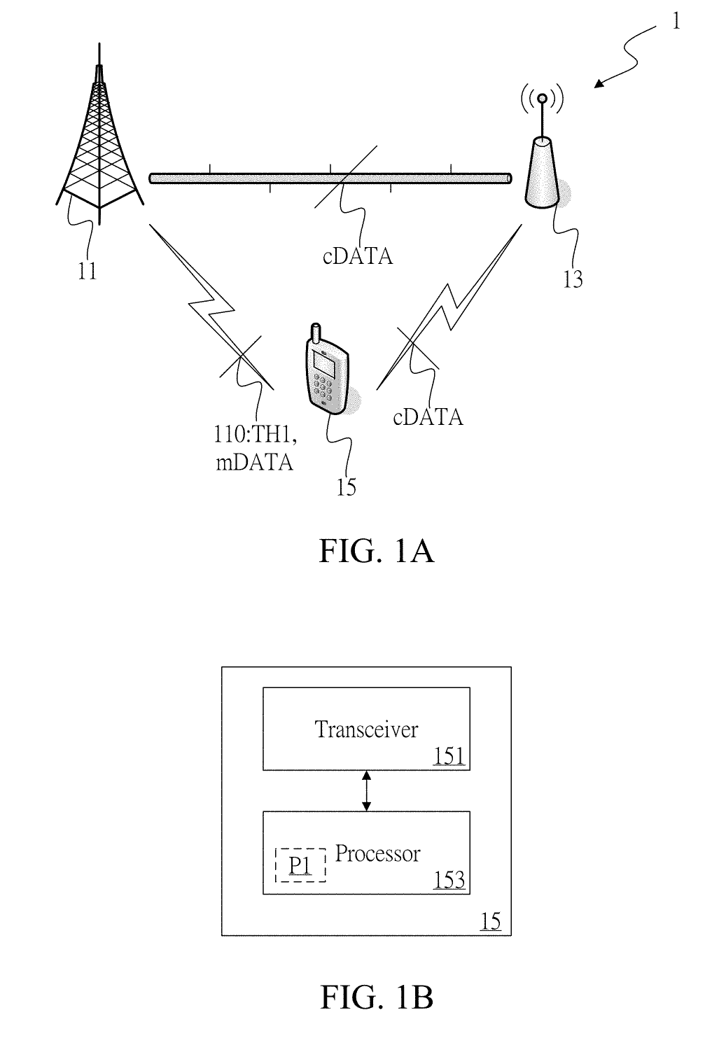

Please refer to FIG. 1A and FIG. 1B. FIG. 1A is a schematic view of a heterogeneous network system 1 according to a first embodiment of the present invention. The heterogeneous network system 1 comprises a Long Term Evolution (LTE) base station 11, a New Radio (NR) base station 13 and a mobile device 15. The LTE base station 11 and the NR base station 13 have a network connection therebetween. FIG. 1B is a block diagram of a mobile device 15 according to the first embodiment of the present invention. The mobile device 15 comprises a transceiver 151 and a processor 153. The aforesaid elements are electrically connected, and interaction among these elements will be further described hereinafter.

First, the transceiver 151 of the mobile device 15 receives a Radio Resource Control (RRC) message 110 from the LTE base station 11. The RRC message 110 comprises a data duplication cease threshold TH1. Next, the processor 153 determines a first under-transmission data parameter P1 of the uplink data to be transmitted by the mobile device 15 within a buffer time period (not shown), and determine whether the first under-transmission data parameter P1 exceeds the data duplication cease threshold TH1.

Next, if the processor 153 of the mobile device 15 determines that the first under-transmission data parameter P1 does not exceed the data duplication cease threshold TH1, the processor 153 initiates a data duplication transmission procedure. The data duplication transmission procedure includes: transmitting, by the processor 153, at least one main datum mDATA to the LTE base station directly through the transceiver 151; and transmitting, by the processor 153, at least one copy datum cDATA of the at least one main datum mDATA to the LTE base station 11 via the NR base station 13 and through the transceiver 151.

In other words, if the processor 153 of the mobile device 15 determines that the first under-transmission data parameter P1 does not exceed the data duplication cease threshold TH1, then it means that the uplink data (including the main datum mDATA and the copy datum cDATA) to be transmitted by the mobile device 15 are still within the processable range of network resources allocated to the mobile device 15 by the LTE base station 11. Therefore, the processor 153 initiates the aforesaid data duplication transmission procedure to efficiently transmit relevant data.

On the other hand, if the processor 153 of the mobile device 15 determines that the first under-transmission data parameter P1 exceeds the data duplication cease threshold TH1, the processor 153 will not initiate the data duplication transmission procedure. In other words, if the processor 153 determines that the first under-transmission data parameter P1 exceeds the data duplication cease threshold TH1, then it means that the uplink data to be transmitted by the mobile device 15 are already beyond the processable range of network resources allocated to the mobile device 15 by the LTE base station 11. Therefore, the processor 153 will not initiate the aforesaid data duplication transmission procedure so as to reduce the loading of the LTE base station 11.

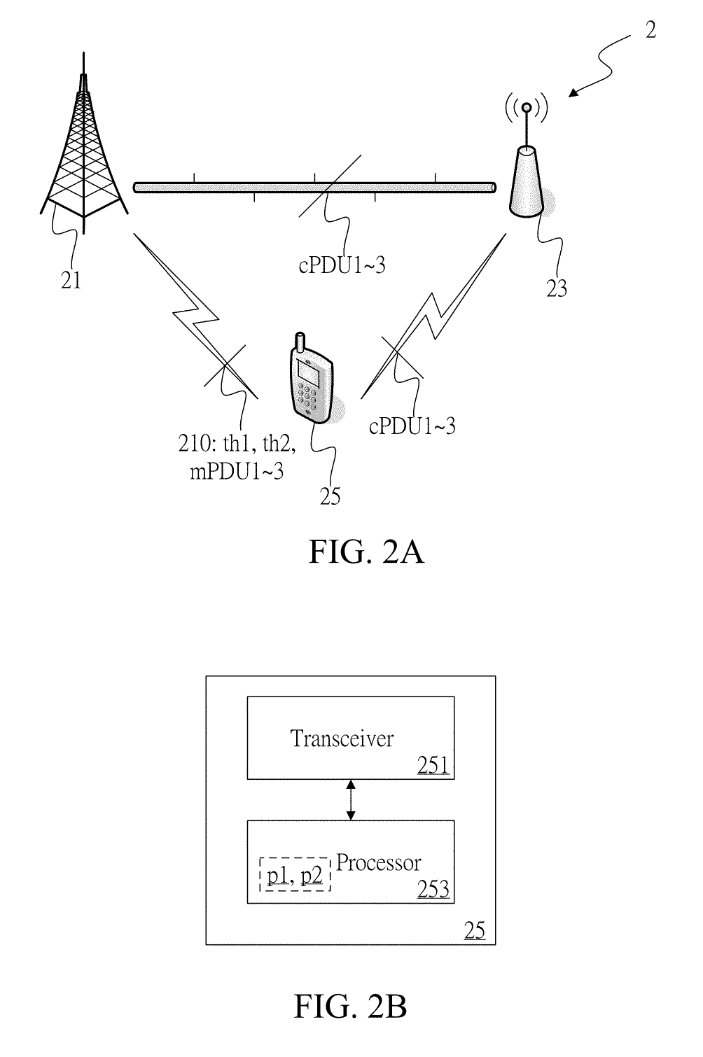

Please refer to FIG. 2A and FIG. 2B. FIG. 2A is a schematic view of a heterogeneous network system 2 according to a second embodiment of the present invention. The heterogeneous network system 2 comprises an LTE base station 21, an NR base station 23 and a mobile device 25. The LTE base station 21 and the NR base station 23 have a network connection therebetween. FIG. 2B is a block diagram of the mobile device 25 according to the second embodiment of the present invention. The mobile device 25 comprises a transceiver 251 and a processor 253. The aforesaid elements are electrically connected. It shall be particularly noted that, the second embodiment mainly further illustrates details about the mobile device of the present invention performing uplink data transmission based on the Packet Data Convergence Protocol (PDCP).

Similarly, first, the transceiver 251 of the mobile device 25 receives an RRC message 210 from the LTE base station 21. The RRC message 210 comprises a data duplication initiation threshold th1 and a data duplication cease threshold th2. Next, the processor 253 determines a first under-transmission data parameter p1 and a second under-transmission data parameter p2 of the uplink data to be transmitted by the mobile device 25 within a buffer time period (not shown).

It shall be particularly noted that, in the second embodiment, the first under-transmission data parameter p1 is an under-transmission data amount accumulated within the buffer time period, and the data initiation threshold th1 is a corresponding data amount threshold. The second under-transmission data parameter p2 is an under-transmission data amount accumulated within the buffer time period, the number of under-transmission packets accumulated within the buffer time period or an LTE network resource utilization ratio. The data duplication cease threshold th2 is a corresponding data amount threshold, under-transmission packet number threshold or an LTE network resource utilization ratio threshold.

Next, the processor 253 of the mobile device 25 first determines whether the first under-transmission data parameter p1 (i.e., the under-transmission data amount accumulated by the mobile device 25 within the buffer time period) exceeds the data duplication initiation threshold th1. If the first under-transmission data parameter p1 does not exceed the data duplication initiation threshold th1, then it means that the data amount of the uplink data accumulated within the buffer time period is small. Therefore, in the case where the data amount of the uplink data is small, the mobile device 25 only needs to transmit the uplink data to the LTE base station 21. In other words, the mobile device 25 does not yet need to transmit the copy datum to the LTE base station 21 via the NR base station 23. Accordingly, the mobile device 25 will not initiate the data duplication procedure.

On the other hand, if the processor 253 of the mobile device 25 determines that the first under-transmission data parameter p1 (i.e., the under-transmission data amount accumulated by the mobile device 25 within the buffer time period) exceeds the data duplication initiation threshold th1, then the processor 253 further determines whether the second under-transmission data parameter p2 (i.e., the under-transmission data amount accumulated within the buffer time period, the number of under-transmission packets accumulated within the buffer time period or an LTE network resource utilization ratio) exceeds the data duplication cease threshold th2.

If the second under-transmission data parameter p2 does not exceed the data duplication cease threshold th2, then the processor 253 initiates a data duplication transmission procedure. The data duplication transmission procedure comprises: transmitting, by the processor 253, a plurality of PDCP main data mPDU1 to mPDU3 to the LTE base station directly through the transceiver 251; and transmitting, by the processor 253, a plurality of PDCP copy data cPUD1 to cPUD3 of the plurality of PDCP main data mPDU1 to mPDU3 to the LTE base station 21 via the NR base station 23 and through the transceiver 251.

In other words, if the processor 253 of the mobile device 25 determines that the second under-transmission data parameter p2 does not exceed the data duplication cease threshold th2, then it means that the uplink data (including the PDCP main data mPDU1 to mPDU3 and the PDCP copy data cPDU1 to cPDU3) to be transmitted by the mobile device 25 are still within the processable range of network resources allocated to the mobile device 25 by the LTE base station 21. Therefore, the processor 253 initiates the aforesaid data duplication transmission procedure to efficiently transmit relevant data.

It shall be particularly emphasized that, in the second embodiment, the processor 253 of the mobile device 25 may also perform a corresponding data transmission schedule for the data type of the uplink data (including the PDCP main data mPDU1 to mPDU3 and the PDCP copy data cPDU1 to cPDU3) while the processor 253 initiates the data duplication transmission procedure, thereby further improving the data transmission efficiency.

For example, for Enhanced Mobile Broadband data having a larger data amount, the processor 253 of the mobile device 25 may first determine a plurality of data transmission end time points F1 to F6 of the PDCP main data mPDU1 to mPDU3 and the PDCP copy data cPDU1 to cPDU3. Next, the processor 253 transmits the PDCP main data mPDU1 to mPDU3 to the LTE base station 21 directly and transmits the corresponding PDCP copy data cPDU1 to cPDU3 to the LTE base station 21 via the NR base station 23 according to the order of the data transmission end time points F1 to F6.

Further speaking, if the data transmission end time points F1 to F6 corresponding to the PDCP main data mPDU1 to mPDU3 and the PDCP copy data cPDU1 to cPDU3 are sorted as F1, F2, F3, F5, F6 and F4 in an ascending order of time, then the processor 253 transmits the corresponding PDCP main data mPDU1 to mPDU3 and the PDCP copy data cPDU1 to cPDU3 in the following order according to the order of the data transmission end time points: mPDU1, mPDU2, mPDU3, cPDU2, cPDU3, and cPDU1. In this way, the overlapping rate in data transmission can be reduced to improve the utilization ratio of network resources.

As another example, for Ultra-Reliable Low Latency Communication data having a smaller data amount and paying more attention to data priority, the processor 253 of the mobile device 25 may first determine a plurality of data transmission start time points a1 to a6 and a plurality of data transmission end time points f1 to f6 of the PDCP main data mPDU1 to mPDU3 and the PDCP copy data cPDU1 to cPDU3. Next, the processor 253 processes the PDCP main data mPDU1 to mPDU3 and the PDCP copy data cPDU1 to cPDU3 in a certain order.

Specifically, during the process that the processor 253 further processes the PDCP main datum mPDU3 after having scheduled the main data mPDU1 and mPDU2, if the processor 253 determines that the data transmission start time point a3 of the PDCP main datum mPDU3 is later than the data transmission end time point f1 of the PDCP main datum mPDU1 and that the data transmission end time point f3 of the PDCP main datum mPDU3 is earlier than the data transmission start time point a2 of the PDCP main datum mPDU2, then it means that idle network resources are available between the PDCP main datum mPDU1 and the PDCP main datum mPDU2 for transmitting the PDCP main datum mPDU3. Therefore, the processor 253 re-establishes a data transmission schedule.

Further speaking, in this data transmission schedule, the processor 253 schedules the PDCP main datum mPDU3 between the PDCP main datum mPDU1 and the PDCP main datum mPDU2 so as to improve the utilization ratio of idle network resources. Next, based on the aforesaid technology, the processor 253 repeats the aforesaid procedure for the subsequent PDCP copy data cPDU1 to cPDU3 to sequentially determine whether the PDCP copy data cPDU1 to cPDU3 can be scheduled between other scheduled PDCP data, and accordingly updates the data transmission schedule. Finally, after all the PDCP data have been processed, the processor 253 transmits the PDCP main data mPDU1 to mPDU3 to the LTE base station 21 directly through the transceiver 251 and transmits the PDCP copy data cPDU1 to cPDU3 to the LTE base station 21 via the NR base station 23 according to the data transmission schedule.

On the other hand, if the processor 253 of the mobile device 25 determines that the second under-transmission data parameter p2 exceeds the data duplication cease threshold th2, the processor 253 will not initiate the data duplication transmission procedure. In other words, if the processor 253 determines that the second under-transmission data parameter p2 exceeds the data duplication cease threshold th2, then it means that the uplink data to be transmitted by the mobile device 25 are already beyond the processable range of network resources allocated to the mobile device 25 by the LTE base station 21. Therefore, the processor 253 will not initiate the aforesaid data duplication transmission procedure so as to reduce the loading of the LTE base station 21.

It shall be particularly noted that, in the aforesaid embodiments, the under-transmission data parameters may be represented separately by any of the under-transmission data amount accumulated within a buffer time period, the number of under-transmission packets accumulated within a buffer time period or an LTE network resource utilization ratio, and the data duplication cease threshold may accordingly be a data amount threshold, an under-transmission packet number threshold or an LTE network resource utilization ratio threshold. However, in other embodiments, the under-transmission data parameters may be the combination of the under-transmission data amount accumulated within a buffer time period, the number of under-transmission packets accumulated within a buffer time period or an LTE network resource utilization ratio, and the data duplication cease threshold may accordingly be the combination of a data amount threshold, an under-transmission packet number threshold or an LTE network resource utilization ratio threshold.

Therefore, in the case where the parameters are used separately, the mobile device determines whether the under-transmission data parameter exceeds the data duplication cease threshold simply for the single parameter being used. On the other hand, in the case where the parameters are used in combination, the mobile device needs to determine whether all the under-transmission data parameters exceed the respective data duplication cease thresholds at the same time for all the parameters being used.

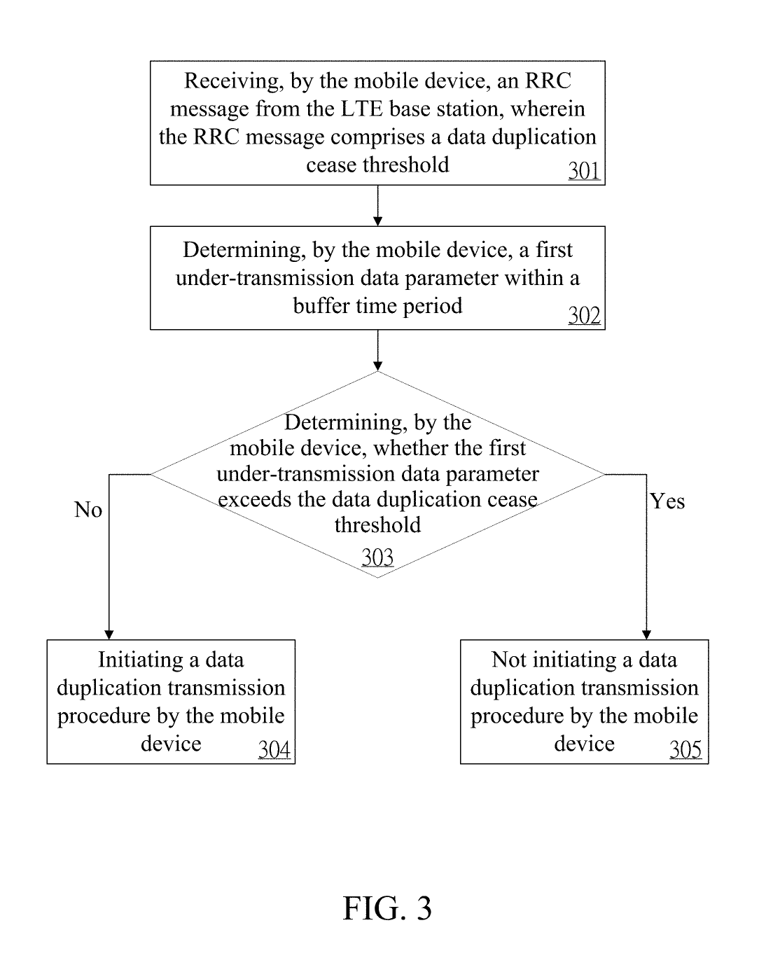

A third embodiment of the present invention is an uplink data transmission method, and a flowchart diagram thereof is as shown in FIG. 3. The uplink data transmission method of the third embodiment is for use in a mobile device (e.g., the mobile device of the aforesaid embodiments). The mobile device is used in a heterogeneous network system that further includes an LTE base station and an NR base station. The LTE base station and the NR base station have a network connection therebetween. The mobile device has a connection with the LTE base station and the NR base station respectively. Detailed steps of the third embodiment are as follows.

First, step 301 is executed to receive an RRC message from the LTE base station by the mobile device. The RRC message comprises a data duplication cease threshold. Step 302 is executed to determine a first under-transmission data parameter within a buffer time period by the mobile device. Step 303 is executed to determine whether the first under-transmission data parameter exceeds the data duplication cease threshold by the mobile device.

Next, if the mobile device determines that the first under-transmission data parameter does not exceed the data duplication cease threshold, step 304 is executed to initiate a data duplication transmission procedure by the mobile device. The data duplication transmission procedure includes: transmitting at least one main datum to the LTE base station directly, and transmitting at least one copy datum of the at least one main datum to the LTE base station via the NR base station by the mobile device. If the mobile device determines that the first under-transmission data parameter exceeds the data duplication cease threshold, step 305 is executed to not initiate the data duplication transmission procedure by the mobile device.

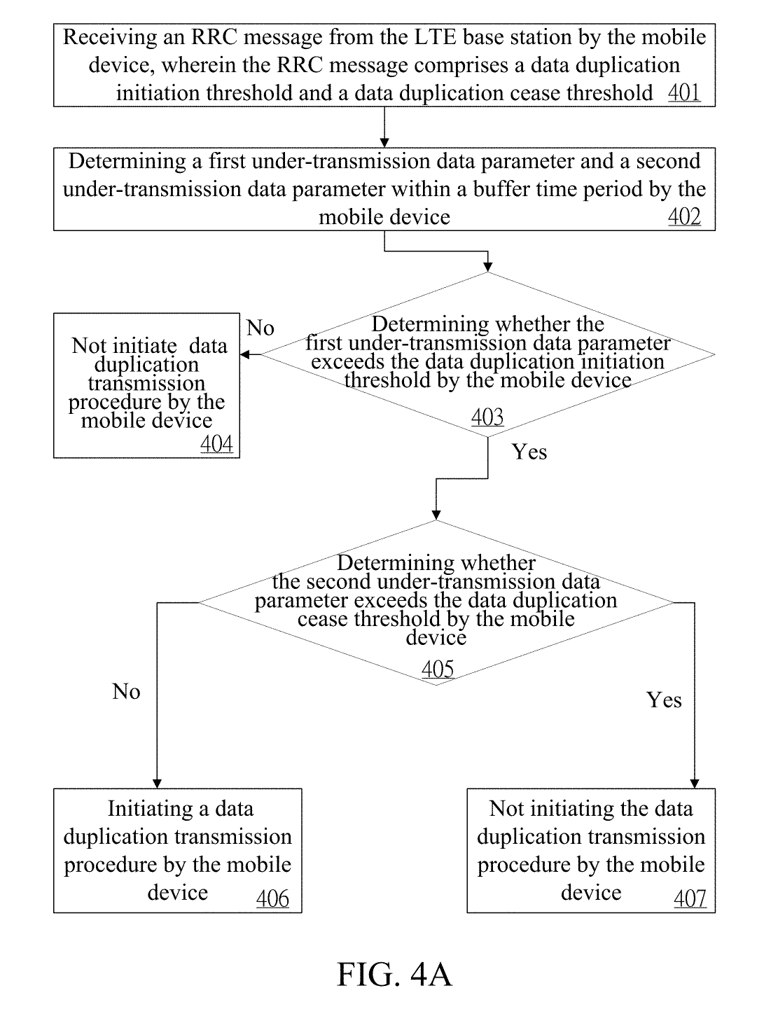

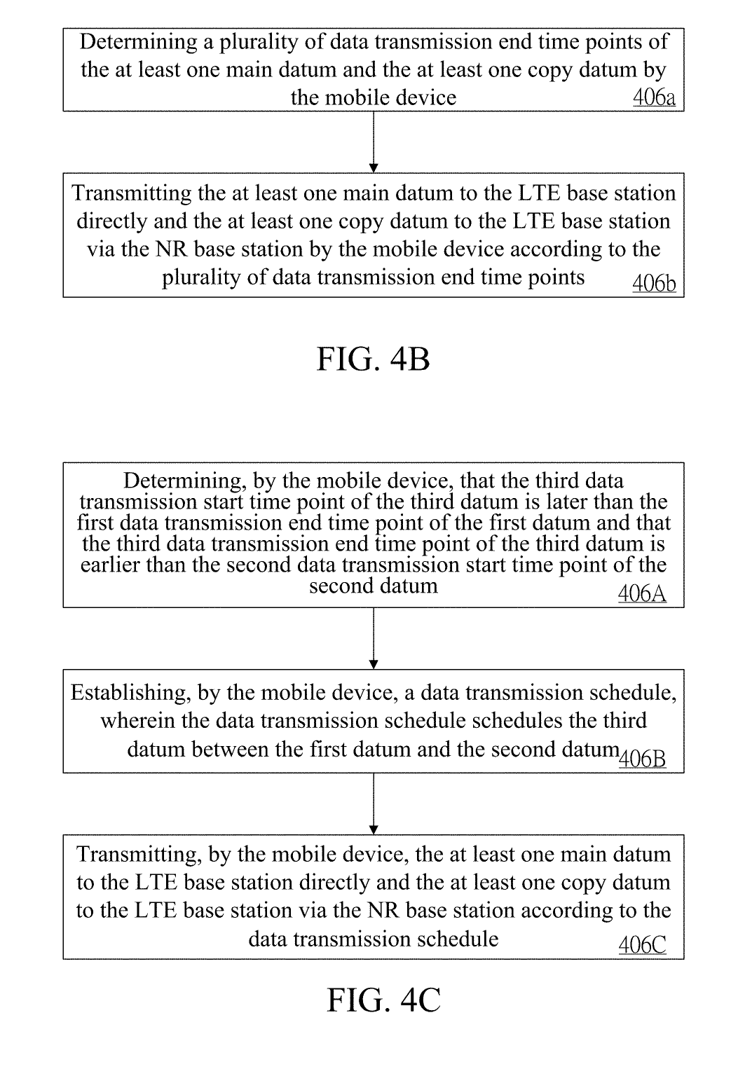

A fourth embodiment of the present invention is an uplink data transmission method, and flowchart diagrams thereof are as shown in FIG. 4A to FIG. 4C. The uplink data transmission method of the fourth embodiment is for use in a mobile device (e.g., the mobile device of the aforesaid embodiments). The mobile device is used in a heterogeneous network system that further includes an LTE base station and an NR base station. The LTE base station and the NR base station have a network connection therebetween. The mobile device has a connection with the LTE base station and the NR base station respectively. Detailed steps of the fourth embodiment are as follows.

First, step 401 is executed to receive an RRC message from the LTE base station by the mobile device. The RRC message comprises a data duplication initiation threshold and a data duplication cease threshold. Step 402 is executed to determine a first under-transmission data parameter and a second under-transmission data parameter within a buffer time period by the mobile device. Step 403 is executed to determine whether the first under-transmission data parameter exceeds the data duplication initiation threshold by the mobile device.

Next, if the mobile device determines that the first under-transmission data parameter does not exceed the data duplication initiation threshold, step 404 is executed to not initiate the data duplication transmission procedure by the mobile device. On the other hand, if the mobile device determines that the first under-transmission data parameter exceeds the data duplication initiation threshold, step 405 is executed to determine whether the second under-transmission data parameter exceeds the data duplication cease threshold by the mobile device.

If the mobile device determines that the second under-transmission data parameter does not exceed the data duplication cease threshold, step 406 is executed to initiate a data duplication transmission procedure by the mobile device. The data duplication transmission procedure includes: transmitting at least one main datum to the LTE base station directly, and transmitting at least one copy datum of the at least one main datum to the LTE base station via the NR base station by the mobile device. On the other hand, if the mobile device determines that the second under-transmission data parameter exceeds the data duplication cease threshold, step 407 is executed to not initiate the data duplication transmission procedure by the mobile device.

It shall be particularly noted that, the data duplication transmission procedure of the step 406 may be performed with different implementation modes for different data types. Referring to FIG. 4B, in one implementation mode, the data duplication transmission procedure of the step 406 may further comprise: executing step 406a to determine a plurality of data transmission end time points of the at least one main datum and the at least one copy datum by the mobile device; and executing step 406b to transmit the at least one main datum to the LTE base station directly and the at least one copy datum to the LTE base station via the NR base station by the mobile device according to the plurality of data transmission end time points.

Referring to FIG. 4C, in another implementation mode, the at least one main datum and the at least one copy datum include a first datum, a second datum and a third datum. The first datum has a first data transmission start time point and a first data transmission end time point. The second datum has a second data transmission start time point and a second data transmission end time point. The third datum has a third data transmission start time point and a third data transmission end time point.

Next, the data duplication transmission procedure of the step 406 may further comprise: executing step 406A to determine, by the mobile device, that the third data transmission start time point of the third datum is later than the first data transmission end time point of the first datum and that the third data transmission end time point of the third datum is earlier than the second data transmission start time point of the second datum; executing step 406B to establish, by the mobile device, a data transmission schedule according to the determination result of the step 406A, wherein the data transmission schedule schedules the third datum between the first datum and the second datum; and executing step 406C to transmit, by the mobile device, the at least one main datum to the LTE base station directly and the at least one copy datum to the LTE base station via the NR base station according to the data transmission schedule.

According to the above descriptions, the mobile device and the uplink data transmission method thereof according to the present invention optimize the process of transmitting the main data and the copy data in the heterogeneous network by the mobile device mainly through determining whether the under-transmission data exceed the preset thresholds, and may further perform fine scheduling for different types of under-transmission data. In this way, the loading of the base station can be reduced and the utilization ratio of network resources is remarkably improved, thereby effectively solving the problem of the prior art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An uplink data transmission method for a mobile device, the mobile device being used in a heterogeneous network system that includes a Long Term Evolution (LTE) base station, a New Radio (NR) base station and the mobile device, the LTE base station and the NR base station having a network connection therebetween, and the mobile device having connections with the LTE base station and the NR base station respectively, the uplink data transmission method comprising:
receiving, by the mobile device, a Radio Resource Control (RRC) message from the LTE base station, wherein the RRC message comprises a data duplication cease threshold;
determining, by the mobile device, a first under-transmission data parameter within a buffer time period;
determining, by the mobile device, whether the first under-transmission data parameter exceeds the data duplication cease threshold:
when the mobile device determines that the first under-transmission data parameter does not exceed the data duplication cease threshold, the mobile device initiates a data duplication transmission procedure which includes: transmitting at least one main datum to the LTE base station directly; and transmitting at least one copy datum of the at least one main datum to the LTE base station via the NR base station; and
when the mobile device determines that the first under-transmission data parameter exceeds the data duplication cease threshold, the mobile device will not initiate the data duplication transmission procedure.

2. The uplink data transmission method of claim 1, wherein the RRC message further comprises a data duplication initiation threshold, and the uplink data transmission method further comprises:
determining, by the mobile device, a second under-transmission data parameter within the buffer time period; and
determining, by the mobile device, whether the first under-transmission data parameter exceeds the data duplication cease threshold after determining that the second under-transmission data parameter exceeds the data duplication initiation threshold.

3. The uplink data transmission method of claim 2, wherein the second under-transmission data parameter is an under-transmission data amount, the data initiation threshold is a corresponding data amount threshold, the first under-transmission data parameter is an under-transmission data amount, the number of under-transmission packets or an LTE network resource utilization ratio, and the data duplication cease threshold is a data amount threshold, an under-transmission packet number threshold or an LTE network resource utilization ratio threshold corresponding to the first under-transmission data parameter.

4. The uplink data transmission method of claim 1, wherein the data duplication transmission procedure further comprises:
determining, by the mobile device, a plurality of data transmission end time points of the at least one main datum and the at least one copy datum; and
transmitting, by the mobile device, the at least one main datum to the LTE base station directly and the at least one copy datum to the LTE base station via the NR base station according to the plurality of data transmission end time points.

5. The uplink data transmission method of claim 1, wherein the at least one main datum and the at least one copy datum include a first datum, a second datum and a third datum, the first datum has a first data transmission start time point and a first data transmission end time point, the second datum has a second data transmission start time point and a second data transmission end time point, the third datum has a third data transmission start time point and a third data transmission end time point, and the data duplication transmission procedure further comprises:
determining, by the mobile device, that the third data transmission start time point of the third datum is later than the first data transmission end time point of the first datum and that the third data transmission end time point of the third datum is earlier than the second data transmission start time point of the second datum;
establishing, by the mobile device, a data transmission schedule according to the determination result that the third data transmission start time point of the third datum is later than the first data transmission end time point of the first datum and that the third data transmission end time point of the third datum is earlier than the second data transmission start time point of the second datum, wherein the data transmission schedule schedules the third datum between the first datum and the second datum; and
transmitting, by the mobile device, the at least one main datum to the LTE base station directly and the at least one copy datum to the LTE base station via the NR base station according to the data transmission schedule.

6. A mobile device for use in a heterogeneous network system, the heterogeneous network system including a Long Term Evolution (LTE) base station, a New Radio (NR) base station and the mobile device, the LTE base station and the NR base station having a network connection therebetween, and the mobile device comprising:
a transceiver, being configured to connect with the LTE base station and the NR base station respectively and receive a Radio Resource Control (RRC) message from the LTE base station, wherein the RRC message comprises a data duplication cease threshold;
a processor, being configured to:
determine a first under-transmission data parameter within a buffer time period;
determine whether the first under-transmission data parameter exceeds the data duplication cease threshold:
when the processor determines that the first under-transmission data parameter does not exceed the data duplication cease threshold, the processor initiates a data duplication transmission procedure which includes: transmitting at least one main datum to the LTE base station directly through the transceiver; and transmitting at least one copy datum of the at least one main datum to the LTE base station via the NR base station and through the transceiver; and
when the processor determines that the first under-transmission data parameter exceeds the data duplication cease threshold, the processor will not initiate the data duplication transmission procedure.

7. The mobile device of claim 6, wherein the RRC message further comprises a data duplication initiation threshold, and the processor is further configured to:
determining a second under-transmission data parameter within the buffer time period; and
determining whether the first under-transmission data parameter exceeds the data duplication cease threshold after determining that the second under-transmission data parameter exceeds the data duplication initiation threshold.

8. The mobile device of claim 7, wherein the second under-transmission data parameter is an under-transmission data amount, the data initiation threshold is a corresponding data amount threshold, the first under-transmission data parameter is an under-transmission data amount, the number of under-transmission packets or an LTE network resource utilization ratio, and the data duplication cease threshold is a data amount threshold, an under-transmission packet number threshold or an LTE network resource utilization ratio threshold corresponding to the first under-transmission data parameter.

9. The mobile device of claim 6, wherein the data duplication transmission procedure further comprises:
determining a plurality of data transmission end time points of the at least one main datum and the at least one copy datum; and
transmitting the at least one main datum to the LTE base station directly through the transceiver and transmitting the at least one copy datum to the LTE base station via the NR base station and through the transceiver according to the plurality of data transmission end time points.

10. The mobile device of claim 6, wherein the at least one main datum and the at least one copy datum include a first datum, a second datum and a third datum, the first datum has a first data transmission start time point and a first data transmission end time point, the second datum has a second data transmission start time point and a second data transmission end time point, the third datum has a third data transmission start time point and a third data transmission end time point, and the data duplication transmission procedure further comprises:
determining that the third data transmission start time point of the third datum is later than the first data transmission end time point of the first datum and that the third data transmission end time point of the third datum is earlier than the second data transmission start time point of the second datum;
establishing a data transmission schedule according to the determination result that the third data transmission start time point of the third datum is later than the first data transmission end time point of the first datum and that the third data transmission end time point of the third datum is earlier than the second data transmission start time point of the second datum, wherein the data transmission schedule schedules the third datum between the first datum and the second datum; and
transmitting the at least one main datum to the LTE base station directly through the transceiver and transmitting the at least one copy datum to the LTE base station via the NR base station and through the transceiver according to the data transmission schedule.
